(19) United States
(12) Patent Application Publication
(10) Pub. No.: US 2023/0174097 A1
(43) Pub. Date: Jun. 8, 2023

(54) AUTONOMOUS DRIVING ASSISTANCE SYSTEM

(71) Applicant: Mitsubishi Electric Corporation, Tokyo (JP)

(72) Inventor: Takatoshi KAKUTA, Tokyo (JP)

(73) Assignee: Mitsubishi Electric Corporation, Tokyo (JP)

(21) Appl. No.: 17/970,136

(22) Filed: Oct. 20, 2022

(30) Foreign Application Priority Data
Dec. 3, 2021 (JP) 2021-196642

(51) Int. Cl. B60W 60/00; G08G 1/0967; B60W 30/14

(52) U.S. Cl. CPC B60W 60/001; B60W 30/14; G08G 1/096783; B60W 2520/10; B60W 2552/30; B60W 2556/35; B60W 2720/10

(57) ABSTRACT

Provided is an autonomous driving assistance system capable of monitoring the whole surrounding area around a vehicle using both of a roadside sensor and a sensor mounted to the vehicle. This autonomous driving assistance system includes a roadside sensor device and an autonomous driving control device mounted to a vehicle in a predetermined area, and an obstacle information processing device which communicates with these. The obstacle information processing device outputs, to the autonomous driving control device of each vehicle in the area, obstacle information around the vehicle, using a first obstacle detection result in an absolute coordinate system which is obstacle information detected by the roadside sensor device and a second obstacle detection result in an absolute coordinate system which is obstacle information detected by a sensor mounted to the vehicle.

### BACKGROUND OF THE INVENTION

### 1. Field of the Invention

The present disclosure relates to an autonomous driving assistance system.

### 2. Description of the Background Art

In recent years, for an advanced driver assistance system (ADAS), vehicles equipped with technologies such as an adaptive cruise control (hereinafter, referred to as ACC) device using various types of sensors such as a millimeter-wave radar, a frontward camera, an ultrasonic sensor, and a surround view camera have been brought to the market.

In the ACC, when there is no preceding vehicle frontward of the own vehicle, the own vehicle is controlled to travel at a constant speed set by a driver, and when there is a preceding vehicle frontward of the own vehicle, the speed of the own vehicle is controlled on the basis of the speed of the preceding vehicle and the vehicle-to-vehicle distance.

In addition, recently, verification tests have been actively conducted domestically and abroad for vehicles equipped with technology of level 4 (enabling autonomous driving under a specific condition) defined by Society of Automotive Engineers (SAE) on the basis of detection for an obstacle using a roadside sensor in a limited area such as a parking lot.

For performing autonomous driving control, technology of performing correction using a roadside sensor when accuracy of a sensor mounted to a vehicle is deteriorated, is disclosed (see, for example, Patent Document 1). In an information processing system disclosed in Patent Document 1, an obstacle present within a predetermined range is detected by both of a roadside sensor and an ADAS vehicular sensor mounted to a vehicle, and correction data for correcting the output of the vehicular sensor is generated on the basis of comparison between an obstacle detection result from the vehicular sensor and an obstacle detection result from the roadside sensor. Then, the correction data is transmitted to the vehicle.

Patent Document 1: WO2021/070750

However, in the information processing system disclosed in Patent Document 1, since a roadside sensor is used for correcting an obstacle detection result from the vehicular sensor, obstacle detection accuracy is enhanced. Meanwhile, in a case where a vehicle is traveling at an intersection, there is a blind spot with only the sensor mounted to the vehicle, and in this case, the sensor cannot detect obstacles such as a preceding vehicle and a pedestrian. In this case, in the method of Patent Document 1, a detection result is not obtained from the vehicular sensor, so that comparison with the roadside sensor cannot be performed. Therefore, there is a problem that it is necessary to enable a vehicle to avoid collision with an obstacle even when the obstacle cannot be detected by a vehicular sensor.

In addition, in a case of monitoring the whole surrounding area around the vehicle using a roadside sensor, there is a problem in terms of the field of view of the roadside sensor, for example, during congestion, a car between large vehicles is in a blind spot for the roadside sensor, so that the car is not detected. Therefore, correction cannot be performed using the roadside sensor through comparison with the vehicular sensor. Thus, there is a problem that it is necessary to enable a car to avoid collision with a large vehicle even when an obstacle cannot be detected by a roadside sensor.

### SUMMARY OF THE INVENTION

The present disclosure has been made to solve the above problems, and an object of the present disclosure is to provide an autonomous driving assistance system that can monitor the whole surrounding area around a vehicle without depending on an intersection, a traffic situation, or the like, by using both of a roadside sensor and a sensor mounted to the vehicle for monitoring the whole surrounding area around the vehicle.

An autonomous driving assistance system according to the present disclosure includes: a roadside sensor device which has a first sensor for detecting an obstacle and outputs a first obstacle detection result in an absolute coordinate system on the basis of the obstacle detected by the first sensor and a mounting position of the roadside sensor device; an autonomous driving control device mounted to a vehicle, and including a second sensor for detecting an obstacle, a locator which acquires and outputs position information of the vehicle, a vehicle sensor fusion unit which outputs a second obstacle detection result in an absolute coordinate system on the basis of the obstacle detected by the second sensor and the position information outputted from the locator, a route information output unit which calculates and outputs a road radius of a road frontward in an advancing direction on a route to a destination, and a vehicle information transmission unit which transmits the second obstacle detection result, the position information outputted from the locator, and the road radius frontward in the advancing direction outputted from the route information output unit; and an obstacle information processing device which communicates with the roadside sensor device and the autonomous driving control device present in a predetermined area, and which, on the basis of the first obstacle detection result outputted from the roadside sensor device, the second obstacle detection result outputted from the autonomous driving control device, the position information outputted from the locator, and the road radius frontward in the advancing direction outputted from the route information output unit, determines an obstacle around the vehicle, and transmits the determined obstacle information around the vehicle to the autonomous driving control device of each vehicle in the area. With the advancing direction of the vehicle defined as a longitudinal direction and a width direction of the vehicle defined as a lateral direction, the obstacle information processing device has a first obstacle output range and a second obstacle output range having different longitudinal-direction ranges and different lateral-direction ranges in accordance with a magnitude of the road radius frontward in the advancing direction outputted from the route information output unit. When the road radius in the advancing direction of the vehicle is smaller than a predetermined threshold, the obstacle information processing device sets, for the vehicle, the second obstacle output range having a greater lateral-direction range and a smaller longitudinal-direction range than the first obstacle output range. When the road radius is equal to or greater than the predetermined threshold, the obstacle information processing device sets the first obstacle output range for the vehicle. The obstacle information processing device transmits, to the autonomous driving control device of each vehicle in the area, the obstacle information around the vehicle in the set first obstacle output range or the set second obstacle output range.

The autonomous driving assistance system according to the present disclosure makes it possible to provide an autonomous driving assistance system that can monitor the whole surrounding area around a vehicle without depending on an intersection, a traffic situation, or the like, by using both of a roadside sensor and a sensor mounted to the vehicle for monitoring the whole surrounding area around the vehicle.

### BRIEF DESCRIPTION OF THE DRAWINGS

FIG. 1 is a block diagram showing the entire configuration of an autonomous driving assistance system according to the first embodiment of the present disclosure;

FIG. 2 is a block diagram showing the configuration of a roadside sensor device according to the first embodiment;

FIG. 3 is a flowchart showing operation of the roadside sensor device according to the first embodiment;

FIG. 4 is a block diagram showing the configuration of an autonomous driving control device of a vehicle in the autonomous driving assistance system according to the first embodiment;

FIG. 5 is a flowchart showing operation of the autonomous driving control device of the vehicle according to the first embodiment;

FIG. 6 is a block diagram showing the configuration of an obstacle information processing device in the autonomous driving assistance system according to the first embodiment;

FIG. 7 is a flowchart showing operation of the obstacle information processing device according to the first embodiment;

FIG. 8 is a block diagram showing the configuration of an object vehicle surrounding obstacle determination unit of the obstacle information processing device according to the first embodiment;

FIG. 9 is a diagram defining the advancing direction of the vehicle in the first embodiment;

FIG. 10 shows an obstacle output range according to the first embodiment;

FIG. 11A shows a part of a flowchart in the object vehicle surrounding obstacle determination unit according to the first embodiment;

FIG. 11B shows a part of a flowchart in the object vehicle surrounding obstacle determination unit according to the first embodiment;

FIG. 11C shows a part of a flowchart in the object vehicle surrounding obstacle determination unit according to the first embodiment;

FIG. 11D shows a part of a flowchart in the object vehicle surrounding obstacle determination unit according to the first embodiment;

FIG. 12 is a flowchart regarding vehicle speed control for the vehicle by the autonomous driving control device according to the first embodiment; and

FIG. 13 is a hardware configuration diagram of each control unit in the autonomous driving assistance system according to the first embodiment.

### DETAILED DESCRIPTION OF THE PREFERRED EMBODIMENTS OF THE INVENTION

Hereinafter, an autonomous driving assistance system according to the present disclosure will be described with reference to the drawings. In the drawings, the same reference characters denote the same or corresponding parts.

### First Embodiment

Hereinafter, an autonomous driving assistance system according to the first embodiment will be described with reference to the drawings.

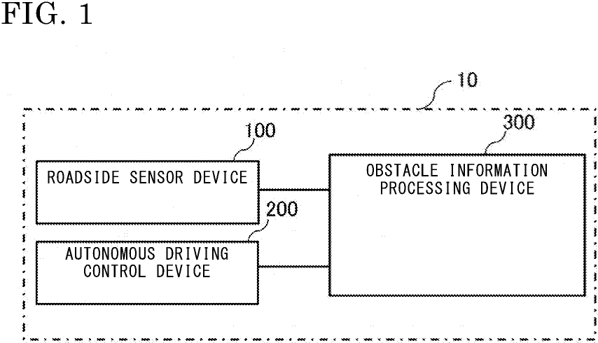

FIG. 1 is a block diagram showing the entire configuration of an autonomous driving assistance system 10 according to the first embodiment. The autonomous driving assistance system 10 includes a roadside sensor device 100, an autonomous driving control device 200 mounted to a vehicle, and an obstacle information processing device 300. The obstacle information processing device 300 in the present embodiment is formed by a multi-access edge computer. The obstacle information processing device 300 performs communication with the roadside sensor device 100 and the autonomous driving control device 200 which are present in a predetermined area. Here, the communication refers to, for example, long term evolution (LTE) or a fifth generation (5G) mobile communication system, and a certain communication speed is ensured. The obstacle information processing device 300 is provided on an area-by-area basis.

Hereinafter, each unit and operation thereof will be described.

### Configuration and Operation of Roadside Sensor Device

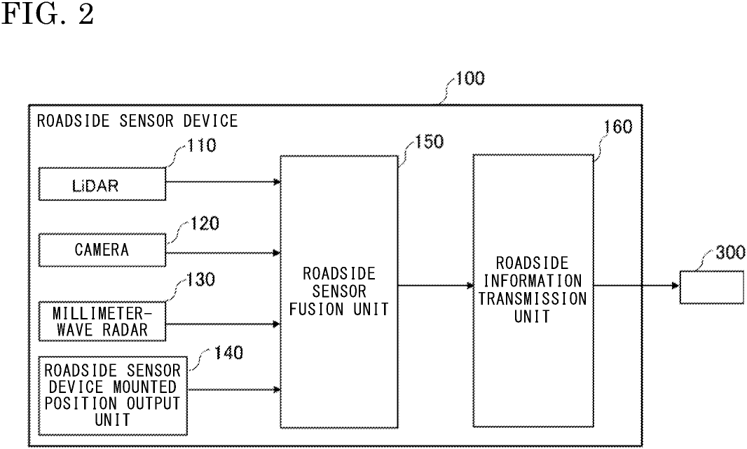

FIG. 2 is a block diagram showing the configuration of the roadside sensor device 100.

The roadside sensor device 100 includes a LiDAR (light detection and ranging) 110, a camera 120, and a millimeter-wave radar 130 which are sensors for detecting a vehicle moving or stopping on a road and an obstacle on the road, a roadside sensor device mounted position output unit 140 which has position information where the roadside sensor device 100 is mounted and which outputs the position information, a roadside sensor fusion unit 150 for calculating a detection result for the obstacle on the road, and a roadside information transmission unit 160 which outputs the detection result for the obstacle on the road to the obstacle information processing device 300. The roadside sensor device 100 is mounted on each of roads including a straight road, an intersection, a road shoulder, and the like so as not to interfere with traffic.

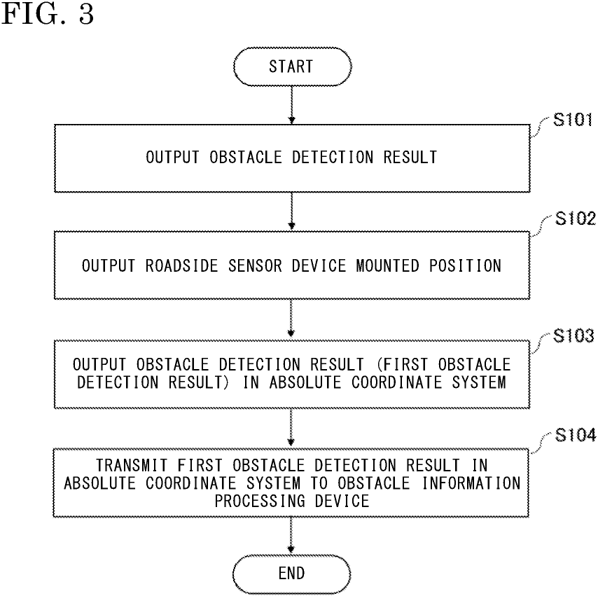

FIG. 3 is a flowchart showing operation of the roadside sensor device 100.

First, in step S101, the LiDAR 110, the camera 120, and the millimeter-wave radar 130 respectively output obstacle detection results to the roadside sensor fusion unit 150. For identifying an obstacle, the camera 120 is used. A sampling period of each sensor is determined in advance in accordance with the frequency of appearance of obstacles and the total number of obstacles at the location where the roadside sensor device 100 is mounted.

Next, in step S102, the roadside sensor device mounted position output unit 140 outputs the position where the roadside sensor device 100 is mounted, to the roadside sensor fusion unit 150. Here, the mounting position of the roadside sensor device 100 has been measured in advance using a high-definition global navigation satellite system (GNSS) receiver. Here, the mounting position of the roadside sensor device 100 is represented by a latitude, a longitude, an altitude, and an orientation.

Next, in step S103, the roadside sensor fusion unit 150 calculates an obstacle detection result (first obstacle detection result) in an absolute coordinate system on the basis of the obstacle detection results from the sensors 110, 120, 130 and the mounting position information of the roadside sensor device 100, and outputs the calculated result.

Finally, in step S104, the roadside information transmission unit 160 transmits the roadside obstacle detection result in the absolute coordinate system calculated by the roadside sensor fusion unit 150, to the obstacle information processing device 300.

### Configuration and Operation of Autonomous Driving Control Device 200

Next, the function and operation of the autonomous driving control device 200 in the autonomous driving assistance system according to the first embodiment will be described.

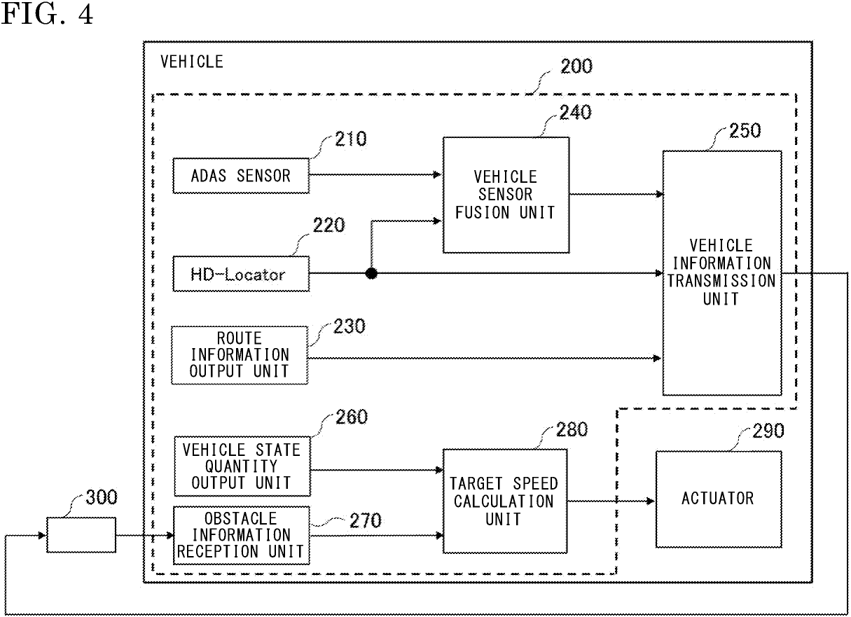

FIG. 4 is a block diagram showing the configuration of the autonomous driving control device 200 mounted to the vehicle. The autonomous driving control device 200 includes an ADAS sensor 210, a high-definition locator (HD-Locator) 220, a route information output unit 230, a vehicle sensor fusion unit 240, a vehicle information transmission unit 250, a vehicle state quantity output unit 260, an obstacle information reception unit 270, and a target speed calculation unit 280, and is mounted to the vehicle together with an actuator 290.

The ADAS sensor 210 is a sensor for detecting an obstacle around the vehicle, and refers to a frontward millimeter-wave radar, a rearward millimeter-wave radar, a frontward camera, an ultrasonic sensor, a surround view camera, and the like, collectively. For identifying an obstacle, the frontward camera is used. The ADAS sensor 210 outputs an obstacle detection result to the vehicle sensor fusion unit 240.

The high-definition locator 220 outputs position information of the vehicle in the absolute coordinate system to the vehicle sensor fusion unit 240 and the vehicle information transmission unit 250. The high-definition locator 220 is provided with a high-definition GNSS receiver, a high-definition map, and a gyro sensor, and outputs a high-definition position of the vehicle in real time. Here, the position of the vehicle is represented by a latitude, a longitude, an altitude, and an orientation.

The route information output unit 230 is set in advance with a destination by a human machine interface (HMI) for destination setting, and outputs a road radius of a road frontward in the advancing direction on a route to the destination of the vehicle, to the vehicle information transmission unit 250. Here, the road radius is a value for determining whether the advancing direction is a straight direction or a curving direction.

The vehicle sensor fusion unit 240 outputs an obstacle detection result (second obstacle detection result) in an absolute coordinate system on the basis of the obstacle detection result from the ADAS sensor 210 and the position information of the vehicle in the absolute coordinate system from the high-definition locator 220.

The vehicle information transmission unit 250 transmits the second obstacle detection result in the absolute coordinate system from the vehicle sensor fusion unit 240, the position information of the vehicle in the absolute coordinate system from the high-definition locator 220, and the road radius frontward in the advancing direction of the vehicle from the route information output unit 230, to the obstacle information processing device 300.

The vehicle state quantity output unit 260 outputs an own-vehicle speed to the target speed calculation unit 280.

The obstacle information reception unit 270 receives obstacle information around the vehicle from the obstacle information processing device 300 as described later and outputs the obstacle information to the target speed calculation unit 280.

The target speed calculation unit 280 calculates a target vehicle speed on the basis of the own-vehicle speed from the vehicle state quantity output unit 260 and the obstacle information around the vehicle from the obstacle information reception unit 270, and outputs the target vehicle speed to the actuator 290. Here, vehicle speeds to be set are determined in advance. The target speed calculation unit 280 is an ACC device which is a known technology, for example.

The actuator 290 controls an accelerator and a brake so that the own-vehicle speed coincides with the target vehicle speed.

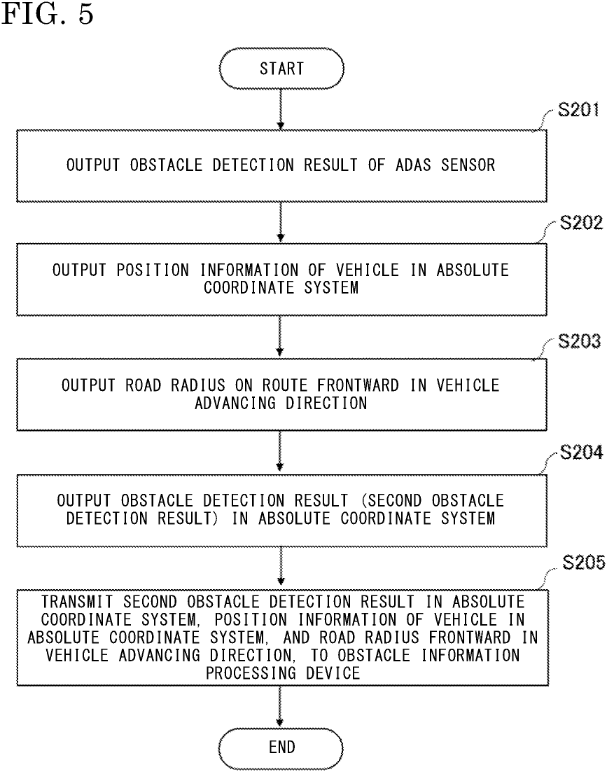

FIG. 5 is a flowchart showing operation for obstacle detection in the autonomous driving control device 200.

First, in step S201, the ADAS sensor 210 mounted to the vehicle detects an obstacle around the vehicle and outputs a result thereof.

Next, in step S202, the position of the vehicle acquired in real time by the high-definition locator 220 is outputted as the position information of the vehicle in the absolute coordinate system.

Next, in step S203, with respect to a destination set in advance and a route thereto, the route information output unit 230 outputs a road radius frontward in the advancing direction on the route to the destination of the vehicle.

Next, in step S204, the vehicle sensor fusion unit 240 outputs the obstacle detection result (second obstacle detection result) in the absolute coordinate system detected by the autonomous driving control device 200 on the basis of the obstacle detection result from the ADAS sensor 210 and the position information of the vehicle from the high-definition locator 220.

Finally, in step S205, the vehicle information transmission unit 250 transmits the second obstacle detection result in the absolute coordinate system calculated by the vehicle sensor fusion unit 240, the position information of the vehicle in the absolute coordinate system acquired by the high-definition locator 220, and the road radius frontward in the vehicle advancing direction outputted from the route information output unit 230, to the obstacle information processing device 300.

### Configuration and Operation of Obstacle Information Processing Device 300

Next, the function and operation of the obstacle information processing device 300 in the autonomous driving assistance system according to the first embodiment will be described.

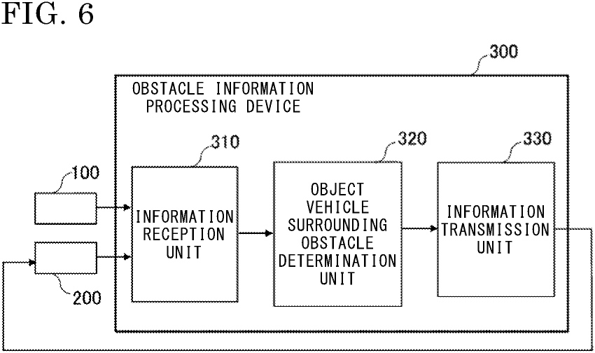

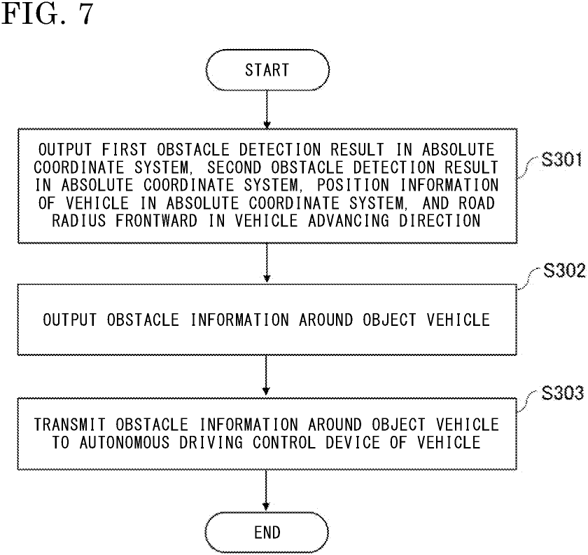

FIG. 6 is a block diagram showing the configuration of the obstacle information processing device 300, and FIG. 7 is a flowchart showing operation of the obstacle information processing device 300. The obstacle information processing device 300 includes an information reception unit 310, an object vehicle surrounding obstacle determination unit 320, and an information transmission unit 330.

In step S301, the information reception unit 310 receives information of the obstacle detection result (first obstacle detection result) from the roadside sensor device 100, and the obstacle detection result (second obstacle detection result), the position information of the vehicle in the absolute coordinate system, and the road radius frontward in the advancing direction of the vehicle from the autonomous driving control device 200, and outputs the information to the object vehicle surrounding obstacle determination unit 320.

In step S302, the object vehicle surrounding obstacle determination unit 320 determines whether or not a detected object is an obstacle around an object vehicle, on the basis of the information received by the information reception unit 310, and outputs obstacle information around the object vehicle.

In step S303, the information transmission unit 330 transmits the obstacle information around the object vehicle to the autonomous driving control device 200 of the vehicle.

### Object Vehicle Surrounding Obstacle Determination Unit 320

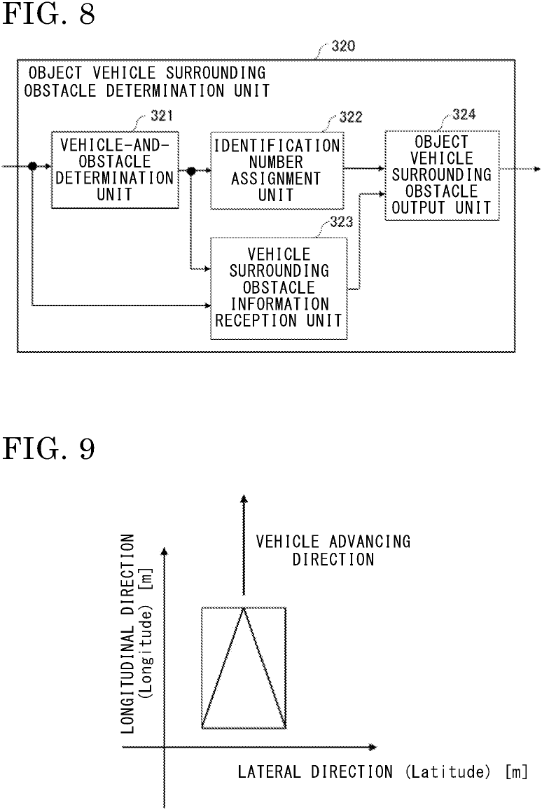

Next, the details of the object vehicle surrounding obstacle determination unit 320 will be described. FIG. 8 is a block diagram showing the configuration of the object vehicle surrounding obstacle determination unit 320. The object vehicle surrounding obstacle determination unit 320 includes a vehicle-and-obstacle determination unit 321, an identification number assignment unit 322, a vehicle surrounding obstacle information reception unit 323, and an object vehicle surrounding obstacle output unit 324.

Using the information received by the information reception unit 310, the vehicle-and-obstacle determination unit 321 determines whether or not a detected object is a vehicle or an obstacle other than a vehicle, on the basis of the position information in the absolute coordinate system about each vehicle in the area, or the first obstacle detection result and the second obstacle detection result. All vehicles are not necessarily provided with high-definition locators. Therefore, the first and second obstacle detection results are also used for determination for whether a vehicle or an obstacle other than a vehicle.

The identification number assignment unit 322 assigns identification numbers from 1 to N to all the vehicles in the area that have been determined to be vehicles by the vehicle-and-obstacle determination unit 321. Here, N is a parameter set in advance and corresponds to the total number of the vehicles in the area.

The vehicle surrounding obstacle information reception unit 323 refers to information of the obstacle determined by the vehicle-and-obstacle determination unit 321, and outputs the information as the first obstacle detection result and the second obstacle detection result in the absolute coordinate system in the area on the basis of the information received by the information reception unit 310. That is, the information of the obstacle imparted with absolute coordinates, including information about whether an obstacle or a vehicle, is outputted.

The object vehicle surrounding obstacle output unit 324 sets, as an object vehicle, the vehicle of each identification number assigned by the identification number assignment unit 322, and determines a range in which presence of an obstacle is to be sent to the object vehicle, on the basis of information of the road radius frontward in the advancing direction of the vehicle outputted from the object vehicle. Then, the object vehicle surrounding obstacle output unit 324 outputs information of obstacles in the range on the basis of the obstacle detection result in the absolute coordinate system from the vehicle surrounding obstacle information reception unit 323.

### Determination of Obstacle Output Range

Here, a method for changing a range in which presence of an obstacle is to be sent to the object vehicle on the basis of information of the road radius frontward in the advancing direction of the vehicle, will be described.

FIG. 9 shows definition of the vehicle advancing direction. A longitudinal direction (Longitude) is defined as the vehicle advancing direction, and a lateral direction (Latitude) is defined as a width direction of the vehicle which is a direction turned clockwise by 90 degrees from the vehicle advancing direction.

As described above, the road radius is a road radius frontward in the advancing direction on the route, and using this value, whether or not the advancing direction is straight or curving is determined. If the road radius is sufficiently great, the road is a straight-advancing road extending straightly (including a mild curve), and the vehicle advances straight. On the other hand, if the road radius on the route is small, the vehicle advances leftward or rightward with the steering wheel turned. Here, a case where the road radius is equal to or greater than a predetermined threshold δ is defined as a straight-advance obstacle output range (first obstacle output range), and a case where the road radius is smaller than the threshold δ is defined as an intersection obstacle output range (second obstacle output range).

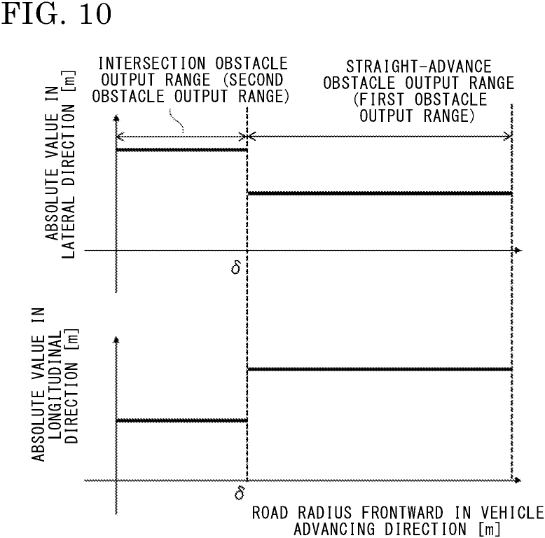

FIG. 10 shows a setting example of the intersection obstacle output range (second obstacle output range) and the straight-advance obstacle output range (first obstacle output range) with respect to the road radius frontward in the vehicle advancing direction. The upper side shows the output range in the lateral direction (Latitude), and the lower side shows the output range in the longitudinal direction (Longitude). Regarding the lateral direction, the intersection obstacle output range is greater than the straight-advance obstacle output range. That is, in order to detect all of obstacles present around the intersection without missing any obstacles, the output range in the lateral direction is set to be great. On the other hand, regarding the longitudinal direction, the straight-advance obstacle output range is greater than the intersection obstacle output range. That is, in order to detect all of obstacles present frontward and rearward in the advancing direction of the vehicle without missing any obstacles, the output range in the longitudinal direction is set to be great.

The threshold δ may be set in accordance with a road type such as an expressway or a general road, the vehicle speed, a congestion state, the total number of vehicles in the area, and the like. For example, in a case of traveling in an urban area or the like, the threshold δ may be set to be greater than in a case of traveling on an expressway so that the second obstacle output range is set to be great with higher priority. Thus, the threshold may be changed as appropriate.

As described above, in the present embodiment, the output range of the obstacle detection result is switched in accordance with the road radius frontward in the advancing direction on the route to the destination of the vehicle, thus making it possible to output information in accordance with the advancing direction of the vehicle.

### Operation of Object Vehicle Surrounding Obstacle Determination Unit 320

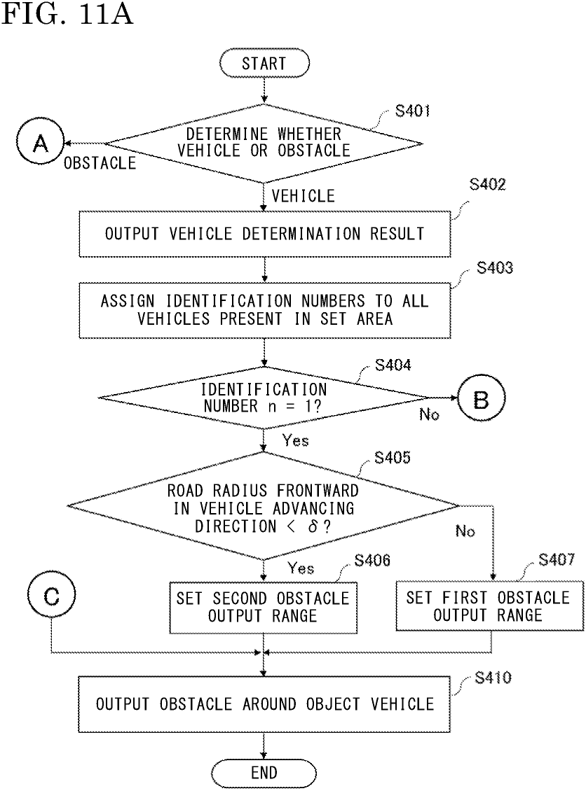

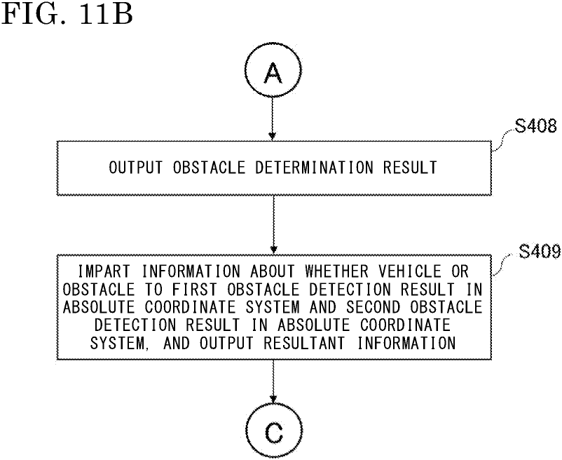

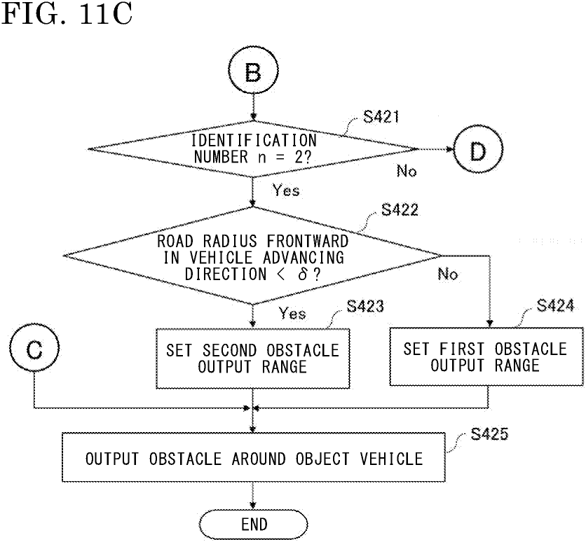

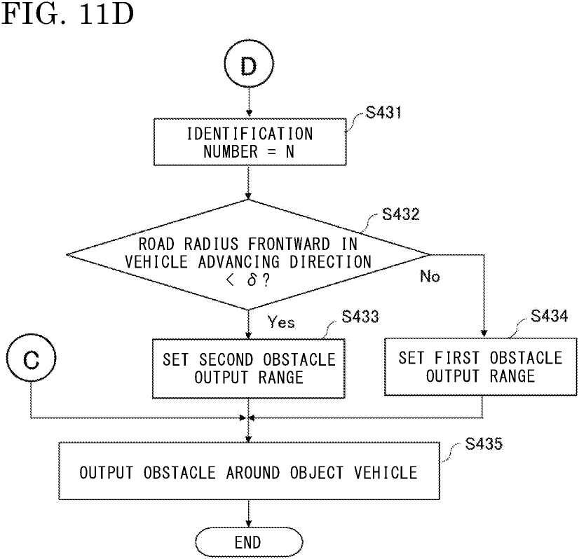

Next, operation of the object vehicle surrounding obstacle determination unit 320 will be described with reference to flowcharts in FIGS. 11A to 11D.

First, in step S401, the vehicle-and-obstacle determination unit 321 determines whether a detected object is a vehicle or an obstacle other than a vehicle, on the basis of the position information in the absolute coordinate system about each vehicle in the area, or the first obstacle detection result and the second obstacle detection result received by the information reception unit 310.

If the detected object is determined to be a vehicle in step S401, in step S402, the vehicle-and-obstacle determination unit 321 outputs the vehicle determination result to the identification number assignment unit 322.

Next, in step S403, the identification number assignment unit 322 assigns identification numbers n (n is a natural number from 1 to N) to all the vehicles in the area determined to be vehicles by the vehicle-and-obstacle determination unit 321.

Next, in step S404, the object vehicle surrounding obstacle output unit 324 determines the identification number of the vehicle, and if the identification number n is 1 (Yes in step S404), the process proceeds to step S405.

In step S405, for the vehicle of the identification number n = 1, whether or not the road radius frontward in the advancing direction of the vehicle is smaller than the threshold δ, is determined. If the road radius is smaller than the threshold δ (Yes in step S405), the process proceeds to step S406. If the road radius is equal to or greater than the threshold δ (No in step S405), the process proceeds to step S407.

If the road radius is smaller than the threshold δ, in step S406, the object vehicle surrounding obstacle output unit 324 sets the second obstacle output range. The second obstacle output range is a range selected because it is determined that, for example, there is an intersection frontward in the vehicle advancing direction when the road radius is smaller than the threshold δ, and thus is the intersection obstacle output range.

If the road radius is equal to or greater than the threshold δ, in step S407, the object vehicle surrounding obstacle output unit 324 sets the first obstacle output range. The first obstacle output range is a range selected because the road in the vehicle advancing direction is determined to be substantially a straight-advancing road when the road radius is equal to or greater than the threshold δ, and thus is the straight-advance obstacle output range.

Returning to step S401, if the detected object is determined to be an obstacle other than a vehicle in step S401, in step S408, the vehicle-and-obstacle determination unit 321 outputs the obstacle determination result to the vehicle surrounding obstacle information reception unit 323.

In step S409, using the result in step S401, the vehicle surrounding obstacle information reception unit 323 imparts information about whether the obstacle is a vehicle or an obstacle other than a vehicle, to information of the first obstacle detection result in the absolute coordinate system from the roadside sensor device 100 and the second obstacle detection result in the absolute coordinate system from the autonomous driving control device 200, and outputs the resultant information to the object vehicle surrounding obstacle output unit 324.

In step S410, the object vehicle surrounding obstacle output unit 324 outputs an obstacle present in the first or second obstacle output range, as a surrounding obstacle around the object vehicle having the identification number n = 1.

Next, in step S404, the object vehicle surrounding obstacle output unit 324 determines the identification number of the vehicle, and if the identification number n is not 1 (No in step S404), the process proceeds to step S421. Then, the object vehicle surrounding obstacle output unit 324 determines the identification number of the vehicle, and if the identification number n is 2 (Yes in step S421), the process proceeds to step S422.

Also for the vehicle of the identification number n = 2, steps S422 to S425 are performed in the same manner as in steps S405 to S407, S410 in the case of the identification number n = 1. Through this operation, the object vehicle surrounding obstacle output unit 324 outputs an obstacle present in the first or second obstacle output range, as a surrounding obstacle around the object vehicle having the identification number n = 2.

Similarly, for each identification number n, the obstacle output range around the corresponding vehicle is set on the basis of the road radius in the vehicle advancing direction of the vehicle, and an obstacle present in this range is outputted as a surrounding obstacle around the vehicle.

Finally, if the identification number n of the vehicle is N (step S431), in step S432, for the vehicle of the identification number n = N, whether or not the road radius frontward in the advancing direction of the vehicle is smaller than the threshold δ is determined. If the road radius is smaller than the threshold δ (Yes in step S432), the process proceeds to step S433. If the road radius is equal to or greater than the threshold δ (No in step S432), the process proceeds to step S434.

If the road radius is smaller than the threshold δ, in step S433, the object vehicle surrounding obstacle output unit 324 sets the second obstacle output range.

If the road radius is equal to or greater than the threshold δ, in step S434, the object vehicle surrounding obstacle output unit 324 sets the first obstacle output range.

In step S435, the object vehicle surrounding obstacle output unit 324 outputs an obstacle present in the first or second obstacle output range, as a surrounding obstacle around the object vehicle having the identification number n = N.

As described above, after identification numbers are assigned to vehicles present in a predetermined area, for each vehicle, the object vehicle surrounding obstacle output unit 324 switches the different first and second obstacle output ranges, e.g., the intersection obstacle output range and the straight-advance obstacle output range, in accordance with the road radius of a road on which the vehicle advances, and outputs information of all obstacles present in the output range.

### Operation of Autonomous Driving Control Device 200 After Obstacle Information Is Received

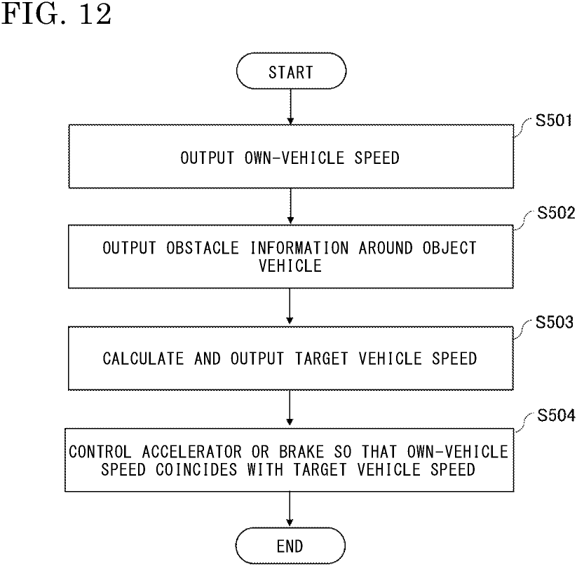

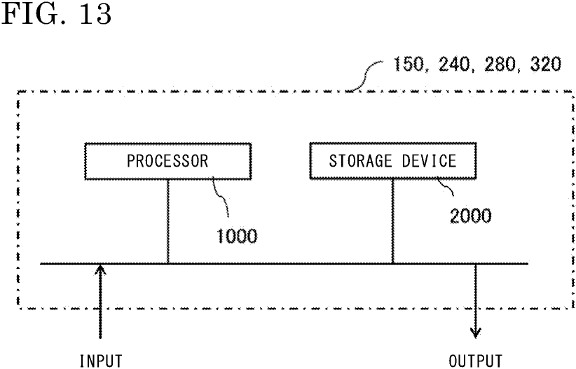

Next, operation of the autonomous driving control device 200 after the obstacle information around the vehicle is transmitted from the information transmission unit 330 of the obstacle information processing device 300 to the autonomous driving control device 200 of each vehicle, will be described with reference to a flowchart in FIG. 12, and FIG. 4.

First, in step S501, the vehicle state quantity output unit 260 outputs the own-vehicle speed to the target speed calculation unit 280.

Next, in step S502, the obstacle information reception unit 270 outputs obstacle information around the object vehicle received from the obstacle information processing device 300, to the target speed calculation unit 280.

In step S503, the target speed calculation unit 280 calculates a target vehicle speed, using the own-vehicle speed and the obstacle information around the object vehicle, and outputs the target vehicle speed to the actuator 290.

In step S504, the actuator 290 controls the accelerator or the brake so that the own-vehicle speed coincides with the target vehicle speed. That is, the autonomous driving control device 200 causes the vehicle to travel in accordance with the target vehicle speed calculated by the target speed calculation unit 280.

As described above, the autonomous driving assistance system according to the first embodiment is the autonomous driving assistance system 10 including the roadside sensor device 100 and the autonomous driving control device 200 mounted to the vehicle in a predetermined area, and the obstacle information processing device 300 which communicates with these. The obstacle information processing device 300 transmits, to each vehicle in the area, obstacle information around the vehicle, using the first obstacle detection result in the absolute coordinate system which is obstacle information detected by the sensor mounted to the roadside sensor device 100, and the second obstacle detection result in the absolute coordinate system which is obstacle information detected by the sensor provided to the autonomous driving control device 200. Thus, there is no dependency on an intersection or a traffic situation and there is no blind spot in obstacle detection, so that information about all obstacles around each vehicle can be grasped. By assisting autonomous driving of the vehicle using the obstacle information around the vehicle, an effect of enabling the whole surrounding area around the vehicle to be monitored and enabling the vehicle to avoid collision with any obstacle, is obtained.

The roadside sensor device 100 includes the roadside sensor device mounted position output unit 140, and thus can easily output, as an obstacle detection result (first obstacle detection result) in an absolute coordinate system, information about an obstacle detected by sensors such as the LiDAR 110, the camera 120, and the millimeter-wave radar 130 provided to the roadside sensor device 100. In addition, the autonomous driving control device 200 of the vehicle includes the high-definition locator 220 for acquiring the position information of the own vehicle, and thus can easily output, as an obstacle detection result (second obstacle detection result) in an absolute coordinate system, information about an obstacle detected by the ADAS sensor 210 for ADAS of the autonomous driving control device 200.

Further, the autonomous driving control device 200 includes the route information output unit 230, and thereby calculates a road radius frontward in the advancing direction on a route to a destination and outputs the road radius to the obstacle information processing device 300. The obstacle information processing device 300 has the first obstacle output range and the second obstacle output range having different longitudinal-direction ranges and different lateral-direction ranges in accordance with a magnitude of the road radius. When the road radius is smaller than a predetermined threshold, the obstacle information processing device 300 sets, for the vehicle, the second obstacle output range having a greater lateral-direction range and a smaller longitudinal-direction range than the first obstacle output range, and when the road radius is equal to or greater than the predetermined threshold, the obstacle information processing device 300 sets the first obstacle output range for the vehicle. Then, the obstacle information processing device 300 transmits, to each vehicle in the area, obstacle information around the vehicle in the set first obstacle output range or the set second obstacle output range. Thus, it becomes possible to transmit information about obstacles in the advancing direction of the vehicle in accordance with the road shape and the traffic situation, efficiently and without missing any obstacles.

That is, as the vehicle advances, when the road radius on the route changes over the threshold so as to become smaller than the threshold from a value equal to or greater than the threshold or become equal to or greater than the threshold from a value smaller than the threshold, the obstacle output range is switched.

Here, for example, when the road radius is smaller than the threshold, the road is an intersection, and when the road radius is equal to or greater than the threshold, the road is a road on which the vehicle advances straight. Thus, the obstacle output range around the vehicle can be switched in accordance with the road shape and the traffic situation.

In addition, the obstacle information processing device 300 includes: the vehicle-and-obstacle determination unit 321 which determines, for the first obstacle detection result and the second obstacle detection result, whether or not each detected obstacle is a vehicle on the basis of position information outputted from the high-definition locator 220 provided to the autonomous driving control device 200 of the vehicle in the area; the identification number assignment unit 322 for assigning an identification number to the vehicle in the area on the basis of the determination result from the vehicle-and-obstacle determination unit 321 and the vehicle position information outputted from the high-definition locator 220 in the area; and the vehicle surrounding obstacle information reception unit 323 which acquires, as the obstacle information around the vehicle, information obtained by imparting information about whether a vehicle or an obstacle other than a vehicle, to the first obstacle detection result and the second obstacle detection result, on the basis of a result from the vehicle-and-obstacle determination unit 321. To each vehicle in the area assigned with the identification number, the obstacle information around the vehicle imparted with obstacle type information is transmitted from the vehicle surrounding obstacle information reception unit 323. Thus, each vehicle can acquire obstacle information around the vehicle together with the type thereof without missing any obstacles. Therefore, there is no dependency on an intersection or a traffic situation and there is no blind spot in obstacle detection, so that information about all obstacles around each vehicle can be grasped. By assisting autonomous driving of the vehicle using the obstacle information around the vehicle, it becomes possible to monitor the whole surrounding area around the vehicle and avoid collision with any obstacle.

At least the roadside sensor fusion unit 150, the vehicle sensor fusion unit 240, the target speed calculation unit 280, and the object vehicle surrounding obstacle determination unit 320 which are control devices in the present embodiment are formed from a processor 1000 and a storage device 2000, as shown in FIG. 13 which shows an example of hardware. The storage device is provided with a volatile storage device such as a random access memory and a nonvolatile auxiliary storage device such as a flash memory, although not shown. Instead of a flash memory, an auxiliary storage device of a hard disk may be provided. The processor 1000 executes a program inputted from the storage device 2000. In this case, the program is inputted from the auxiliary storage device to the processor 1000 via the volatile storage device. The processor 1000 may output data such as a calculation result to the volatile storage device of the storage device 2000, or may store such data into the auxiliary storage device via the volatile storage device.

Each of the roadside sensor device 100, the autonomous driving control device 200, and the obstacle information processing device 300 may have the hardware configuration shown in FIG. 13.

### Modifications of First Embodiment

(1) For the roadside sensor device 100, three sensors, i.e., the LiDAR 110, the camera 120, and the millimeter-wave radar 130 are used for detecting obstacles, as an example. However, without limitation thereto, more sensors may be provided. Not all the roadside sensor devices 100 in the area need to be provided with three sensors. However, for identifying an obstacle, the camera 120 is needed. Providing many sensors enhances obstacle detection accuracy, but it suffices that sensors are provided so as to be able to cover the area.

(2) The first and second obstacle output ranges are set in accordance with the magnitude of the road radius frontward in the advancing direction of the vehicle, but the configuration is not limited to such two-level setting. For example, for a curve having a small road radius not corresponding to an intersection, a third range at a medium position between the first and second obstacle output ranges may be set.

(3) In setting of the obstacle output range, not only the magnitude of the road radius frontward in the advancing direction of the vehicle but also map information may be used in combination to determine the road situation such as an intersection, thus setting the obstacle output range.

Although the disclosure is described above in terms of the exemplary embodiment, it should be understood that the various features, aspects, and functionality described in the embodiment are not limited in their applicability to the particular embodiment with which they are described, but instead can be applied, alone or in various combinations to the embodiment of the disclosure.

It is therefore understood that numerous modifications which have not been exemplified can be devised without departing from the scope of the present disclosure. For example, at least one of the constituent components may be modified, added, or eliminated. At least one of the constituent components mentioned in the embodiment may be selected and combined with the constituent components mentioned in another embodiment.

### DESCRIPTION OF THE REFERENCE CHARACTERS

10 autonomous driving assistance system
100 roadside sensor device
110 LiDAR
120 camera
130 millimeter-wave radar
140 roadside sensor device mounted position output unit
150 roadside sensor fusion unit
160 roadside information transmission unit
200 autonomous driving control device
210 ADAS sensor
220 high-definition locator (HD-Locator)
230 route information output unit
240 vehicle sensor fusion unit
250 vehicle information transmission unit
260 vehicle state quantity output unit
270 obstacle information reception unit
280 target speed calculation unit
290 actuator
300 obstacle information processing device
310 information reception unit
320 object vehicle surrounding obstacle determination unit
321 vehicle-and-obstacle determination unit
322 identification number assignment unit
323 vehicle surrounding obstacle information reception unit
324 object vehicle surrounding obstacle output unit
330 information transmission unit
1000 processor
2000 storage device

What is claimed is:

1. An autonomous driving assistance system comprising:
a roadside sensor device which has a first sensor for detecting an obstacle and outputs a first obstacle detection result in an absolute coordinate system on the basis of the obstacle detected by the first sensor and a mounting position of the roadside sensor device;
an autonomous driving control device mounted to a vehicle, and including a second sensor for detecting an obstacle, a locator which acquires and outputs position information of the vehicle, a vehicle sensor fusor which outputs a second obstacle detection result in an absolute coordinate system on the basis of the obstacle detected by the second sensor and the position information outputted from the locator, a route information output which calculates and outputs a road radius of a road frontward in an advancing direction on a route to a destination, and a vehicle information transmitter which transmits the second obstacle detection result, the position information outputted from the locator, and the road radius frontward in the advancing direction outputted from the route information output; and
an obstacle information processing device which communicates with the roadside sensor device and the autonomous driving control device present in a predetermined area, and which, on the basis of the first obstacle detection result outputted from the roadside sensor device, the second obstacle detection result outputted from the autonomous driving control device, the position information outputted from the locator, and the road radius frontward in the advancing direction outputted from the route information output, determines an obstacle around the vehicle, and transmits the determined obstacle information around the vehicle to the autonomous driving control device of each vehicle in the area, wherein
with the advancing direction of the vehicle defined as a longitudinal direction and a width direction of the vehicle defined as a lateral direction, the obstacle information processing device has a first obstacle output range and a second obstacle output range having different longitudinal-direction ranges and different lateral-direction ranges in accordance with a magnitude of the road radius frontward in the advancing direction outputted from the route information output,
when the road radius in the advancing direction of the vehicle is smaller than a predetermined threshold, the obstacle information processing device sets, for the vehicle, the second obstacle output range having a greater lateral-direction range and a smaller longitudinal-direction range than the first obstacle output range,
when the road radius is equal to or greater than the predetermined threshold, the obstacle information processing device sets the first obstacle output range for the vehicle, and
the obstacle information processing device transmits, to the autonomous driving control device of each vehicle in the area, the obstacle information around the vehicle in the set first obstacle output range or the set second obstacle output range.

2. The autonomous driving assistance system according to claim 1, wherein
the obstacle information processing device transmits, to the autonomous driving control device of each vehicle in the area, the obstacle information around the vehicle by switching between the set first obstacle output range and the set second obstacle output range in accordance with the road radius in the advancing direction of the vehicle.

3. The autonomous driving assistance system according to claim 1, wherein
the obstacle information processing device includes
a vehicle-and-obstacle determiner which determines, for the first obstacle detection result and the second obstacle detection result, whether or not each obstacle in the first obstacle detection result and the second obstacle detection result is a vehicle, on the basis of the position information outputted from the locator of the vehicle in the area, and
an identification number assignor which assigns an identification number to the vehicle in the area on the basis of a determination result from the vehicle-and-obstacle determiner and the position information outputted from the locator of the vehicle in the area, and
the obstacle information processing device transmits the obstacle information around the vehicle, to the autonomous driving control device of each vehicle in the area assigned with each identification number.

4. The autonomous driving assistance system according to claim 3, wherein
the obstacle information processing device further includes a vehicle surrounding obstacle information receptor which acquires, as the obstacle information around the vehicle, information obtained by imparting information about whether a vehicle or an obstacle other than a vehicle to the first obstacle detection result and the second obstacle detection result on the basis of a result from the vehicle-and-obstacle determiner, and
the obstacle information processing device transmits the obstacle information around the vehicle outputted from the vehicle surrounding obstacle information receptor, to the autonomous driving control device of each vehicle in the area assigned with each identification number.

5. The autonomous driving assistance system according to claim 1, wherein
the obstacle information processing device determines the road to be a straight-advancing road, when the road radius is equal to or greater than the predetermined threshold.

6. The autonomous driving assistance system according to claim 1, wherein
the autonomous driving control device of the vehicle includes a target speed calculator which calculates a target vehicle speed using an own-vehicle speed and the obstacle information around the vehicle transmitted from the obstacle information processing device, and causes the vehicle to travel in accordance with the target vehicle speed calculated by the target speed calculator.

7. The autonomous driving assistance system according to claim 6, wherein
the target speed calculator is an adaptive cruise control device.

8. An autonomous driving assistance system comprising:
a roadside sensor device which has a first sensor for detecting an obstacle and outputs a first obstacle detection result in an absolute coordinate system on the basis of the obstacle detected by the first sensor and a mounting position of the roadside sensor device;
an autonomous driving control device mounted to a vehicle, and including a second sensor for detecting an obstacle, a locator which acquires and outputs position information of the vehicle, a vehicle sensor fusor which outputs a second obstacle detection result in an absolute coordinate system on the basis of the obstacle detected by the second sensor and the position information outputted from the locator, a route information output which calculates and outputs a road radius of a road frontward in an advancing direction on a route to a destination, and a vehicle information transmitter which transmits the second obstacle detection result, the position information outputted from the locator, and the road radius frontward in the advancing direction outputted from the route information output; and
an obstacle information processing device which communicates with the roadside sensor device and the autonomous driving control device present in a predetermined area, and which, on the basis of the first obstacle detection result outputted from the roadside sensor device, the second obstacle detection result outputted from the autonomous driving control device, the position information outputted from the locator, and the road radius frontward in the advancing direction outputted from the route information output, determines an obstacle around the vehicle, and transmits the determined obstacle information around the vehicle to the autonomous driving control device of each vehicle in the area, wherein
the obstacle information processing device includes
a vehicle-and-obstacle determiner which determines, for the first obstacle detection result and the second obstacle detection result, whether or not each obstacle in the first obstacle detection result and the second obstacle detection result is a vehicle, on the basis of the position information outputted from the locator in the area,
an identification number assignor which assigns an identification number to the vehicle in the area on the basis of a determination result from the vehicle-and-obstacle determiner and the position information outputted from the locator in the area, and
a vehicle surrounding obstacle information receptor which acquires, as the obstacle information around the vehicle, information obtained by imparting information about whether a vehicle or an obstacle other than a vehicle to the first obstacle detection result and the second obstacle detection result on the basis of a result from the vehicle-and-obstacle determiner, and
the obstacle information processing device transmits the obstacle information around the vehicle outputted from the vehicle surrounding obstacle information receptor, to the autonomous driving control device of each vehicle in the area assigned with each identification number.

9. The autonomous driving assistance system according to claim 8, wherein
the autonomous driving control device of the vehicle includes a target speed calculator which calculates a target vehicle speed using an own-vehicle speed and the obstacle information around the vehicle transmitted from the obstacle information processing device, and causes the vehicle to travel in accordance with the target vehicle speed calculated by the target speed calculator.

10. The autonomous driving assistance system according to claim 9, wherein
the target speed calculator is an adaptive cruise control device.
